(19) United States
(12) Patent Application Publication
(10) Pub. No.: US 2025/0061412 A1
(43) Pub. Date: Feb. 20, 2025

(54) SERVER DEVICE, DELIVERY STATUS DISPLAY SYSTEM, DELIVERY STATUS RESPONSE METHOD, AND RECORDING MEDIUM

(71) Applicant: Rakuten Group, Inc., Tokyo (JP)

(72) Inventors: Taishin MURASE, Tokyo (JP); Kunal VYAS, Tokyo (JP)

(73) Assignee: Rakuten Group, Inc., Tokyo (JP)

(21) Appl. No.: 18/806,283

(22) Filed: Aug. 15, 2024

(30) Foreign Application Priority Data
Aug. 16, 2023 (JP) 2023-132680

(51) Int. Cl. G06Q 10/0835

(52) U.S. Cl. CPC G06Q 10/08355

(57) ABSTRACT

An acquirer acquires a current location from a deliverer terminal being used by a deliverer. A calculator calculates, based on the acquired current location and delivery route information including a delivery destination where the deliverer stops for a delivery, an estimated time of delivery at which the deliverer is expected to be able to make a delivery to the user. A generator generates, in response to the inquiry information received by the receiver, response information including the estimated time of delivery. A transmitter transmits the generated response information to the user terminal. Then, the generator generates, based on the delivery route information, the response information further including the current location only when there is no other delivery destination between the current location and a delivery to the user.

### CROSS-REFERENCE TO RELATED APPLICATIONS

This application claims the benefit of Japanese Patent Application No. 2023-132680, filed on Aug. 16, 2023, the entire disclosure of which is incorporated by reference herein.

### FIELD OF THE INVENTION

The present disclosure relates to a server device, a delivery status display system, a delivery status response method, and a recording medium.

### BACKGROUND OF THE INVENTION

In recent years, e-commerce has become widespread, and many deliveries of purchased items have been made accordingly. For example, an item purchased online by a user through a so-called “online grocer” is delivered to a user's home by a dedicated or affiliated delivery company. Note that, if a user is not at home at a time of delivery, the delivery is not completed, resulting in a re-delivery. Thus, for example, a delivery notification service that notifies a user of the delivery by an e-mail or the like on the day before or on the day of the delivery to encourage the user to be at home has also become widespread. Nevertheless, when the delivery is not a timed delivery, the delivery notification service only notifies a date of delivery, and thus, a user has to remain at home on the date of delivery and wait all day (until the delivery is made). Further, even when the delivery is a timed delivery, there is a range of several hours for a specified time period, and thus, a user still has to remain at home in the specified time period and wait for a long time.

Thus, a system that allows a user to inquire about a time of delivery (time of arrival of a package) has also been developed recently. For example, Unexamined Japanese Patent Application Publication No. 2002-284353 discloses an invention of a delivery time inquiry system (parcel delivery time inquiry system) capable of responding to an inquiry from a user about a time of arrival of a package.

In the invention described in Unexamined Japanese Patent Application Publication No. 2002-284353, a user can inquire a current location of a package (current location of a transportation vehicle) and a time of delivery (scheduled time of delivery) by inputting information relating to the package on an inquiry screen (parcel delivery time inquiry screen as illustrated in FIG. 4).

Incidentally, when an actual delivery is made, not only a delivery addressed to a user making an inquiry but also a delivery addressed to another user is also made. For example, a deliverer (delivery company) makes deliveries along a delivery route including a plurality of delivery destinations where he/she stops for a delivery.

Further, as in the above-described invention described in Unexamined Japanese Patent Application Publication No. 2002-284353, when a user inquires a time of delivery or the like, the inquiry is expected to be repeated a plurality of times, not just once.

However, in the invention described in Unexamined Japanese Patent Application Publication No. 2002-284353, there is a risk that a user can estimate a delivery addressed to another user by repeating the inquiry a plurality of times.

In other words, in the invention described in Unexamined Japanese Patent Application Publication No. 2002-284353, since not only a time of delivery but also a current location of a package can be inquired without limitation, there is a problem that a user can estimate another user's home where a delivery may have been made from a trajectory (as an example, a travel route and a stop for a predetermined period of time or more) of current locations acquired by repeating the inquiry.

Due to such a circumstance, there has been a need for a technique that can present a delivery status to a user intelligibly while protecting privacy.

### SUMMARY OF THE INVENTION

The present disclosure has been made in view of the above-described circumstance, and an objective of the present disclosure is to provide a server device, a delivery status display system, a delivery status response method, and a recording medium that can present a delivery status to a user intelligibly while protecting privacy.

A server device according to a first point of view of the present disclosure includes:
an acquirer acquiring a current location from a deliverer terminal being used by a deliverer who delivers an item to a user;
a calculator calculating, based on the current location acquired by the acquirer and delivery route information including a delivery destination where the deliverer stops for a delivery, an estimated time of delivery at which the deliverer is expected to be able to make a delivery to the user;
a receiver receiving inquiry information transmitted from a user terminal being used by the user;
a generator generating, in response to the inquiry information received by the receiver, response information including the estimated time of delivery calculated by the calculator; and
a transmitter transmitting the response information generated by the generator to the user terminal,
wherein the generator generates, based on the delivery route information, the response information further including the current location only when there is no other delivery destination between the current location and a delivery to the user.

Further, in the server device according to the above-described point of view, the generator may generate the response information including a map image on which a mark indicating the current location is superimposed and a message indicating the estimated time of delivery or time remaining until the estimated time of delivery only when there is no other delivery destination between the current location and a delivery to the user.

Further, the server device according to the above-described point of view may further include:
an updater controlling the acquirer and the calculator to update the current location and the estimated time of delivery at each predetermined time interval; and
a notifier notifying the user terminal of advance notice information that a delivery is about to be made soon when time remaining until the estimated time of delivery goes below a predetermined threshold value.

A delivery status display system according to a second point of view of the present disclosure is a delivery status display system in which a deliverer terminal being used by a deliverer who delivers an item to a user, a user terminal being used by a user, and a server device are communicably connected, wherein
the user terminal includes:
   a terminal transmitter transmitting inquiry information to the server device;
   a terminal receiver receiving response information rent from the server device; and
   a display displaying the response information received by the terminal receiver,
the server device includes:
   an acquirer acquiring a current location from the deliverer terminal;
   a calculator calculating, based on the current location acquired by the acquirer and delivery route information including a delivery destination where the deliverer stops for a delivery, an estimated time of delivery at which the deliverer is expected to be able to make a delivery to the user;
   a receiver receiving the inquiry information transmitted from the user terminal;
   a generator generating, in response to the inquiry information received by the receiver, the response information including the estimated time of delivery calculated by the calculator; and
   a transmitter transmitting the response information generated by the generator to the user terminal, and
the generator generates, based on the delivery route information, the response information further including the current location only when there is no other delivery destination between the current location and a delivery to the user.

A delivery status response method according to a third point of view of the present disclosure is a delivery status response method executed by a server device, and includes:
acquiring a current location from a deliverer terminal being used by a deliverer who delivers an item to a user;
calculating, based on the acquired current location and delivery route information including a delivery destination where the deliverer stops for a delivery, an estimated time of delivery at which the deliverer is expected to be able to make a delivery to the user;
receiving inquiry information transmitted from a user terminal being used by the user;
generating, in response to the received inquiry information, response information including the calculated estimated time of delivery; and
transmitting the generated response information to the user terminal,
wherein the generating includes generating, based on the delivery route information, the response information further including the current location only when there is no other delivery destination between the current location and a delivery to the user.

An information recording medium according to a fourth point of view of the present disclosure is a non-transitory computer-readable recording medium recording a program, the program causing a computer to execute processing comprising:
acquiring a current location from a deliverer terminal being used by a deliverer who delivers an item to a user;
calculating, based on the acquired current location and delivery route information including a delivery destination where the deliverer stops for a delivery, an estimated time of delivery at which the deliverer is expected to be able to make a delivery to the user;
receiving inquiry information transmitted from a user terminal being used by the user;
generating, in response to the received inquiry information, response information including the calculated estimated time of delivery; and
transmitting the generated response information to the user terminal,
wherein the generating includes generating, based on the delivery route information, the response information further including the current location only when there is no other delivery destination between the current location and a delivery to the user.

The above-described information recording medium is a non-transitory recording medium, and can be distributed and sold independently of a computer. Herein, the non-transitory recording medium refers to a tangible recording medium. The non-transitory recording medium is, for example, a compact disc, a flexible disk, a hard disk, a magneto-optical disk, a digital video disc, a magnetic tape, a semiconductor memory, or the like. Further, a transitory recording medium indicates a transmission medium (propagation signal) per se. The transitory recording medium is, for example, an electrical signal, an optical signal, an electromagnetic wave, or the like. Note that, a temporary storage area is an area for temporarily storing data or a program, and is, for example, a volatile memory such as a random access memory (RAM).

### BRIEF DESCRIPTION OF DRAWINGS

A more complete understanding of this application can be obtained when the following detailed description is considered in conjunction with the following drawings, in which:

FIG. 1 is a block diagram illustrating one example of an overall configuration of a delivery status display system according to the present embodiment;

FIG. 2 is a block diagram illustrating one example of a summary configuration of a typical information processing device achieving a server device, a user terminal, and the like;

FIG. 3 is a block diagram illustrating one example of a functional configuration of a server device according to Embodiment 1;

FIG. 4 is a schematic diagram for describing delivery route information;

FIG. 5 is a schematic diagram illustrating one example of update rule information;

FIGS. 6A and 6B are both schematic diagrams illustrating one example of generated response information;

FIG. 7 is a block diagram illustrating one example of a functional configuration of a user terminal according to Embodiment 1;

FIG. 8A is a schematic diagram illustrating one example of a push notification displayed on the user terminal, and FIG. 8B is a schematic diagram illustrating one example of response information displayed on the user terminal;

FIG. 9 is a flowchart for describing delivery status response processing and delivery status inquiry processing according to Embodiment 1;

FIG. 10 is a block diagram illustrating one example of a functional configuration of a server device according to Embodiment 2;

FIGS. 11A and 11B are both schematic diagrams illustrating one example of generated response information;

FIG. 12 is a block diagram illustrating one example of a functional configuration of a user terminal according to Embodiment 2;

FIGS. 13A and 13B are both schematic diagrams illustrating one example of response information displayed on the user terminal;

FIG. 14 is a flowchart for describing delivery status response processing and delivery status inquiry processing according to Embodiment 2;

FIG. 15 is a block diagram illustrating one example of a functional configuration of a server device according to Embodiment 3;

FIGS. 16A and 16B are both schematic diagrams illustrating one example of generated response information; and

FIG. 17 is a flowchart for describing delivery status response processing according to Embodiment 3.

### DETAILED DESCRIPTION OF THE INVENTION

Embodiments of the present disclosure are described below. In the embodiments of the present disclosure, description is given using an example of a so-called “online grocer” that accepts an order for an item (product) via a network and delivers the item to a neighborhood user. However, the embodiments of the present disclosure are not limited to such a case of delivering an item purchased at an online grocer, but are similarly applicable to a case of delivering an item purchased through various types of e-commerce transactions.

In other words, the embodiments below are for illustrative purposes only and are not intended to limit the scope of the present disclosure. Therefore, a person skilled in the art can adopt the embodiments in which each or all of the elements thereof are substituted by equivalents thereto, but the embodiments are also included in the scope of the present disclosure.

### Embodiment 1

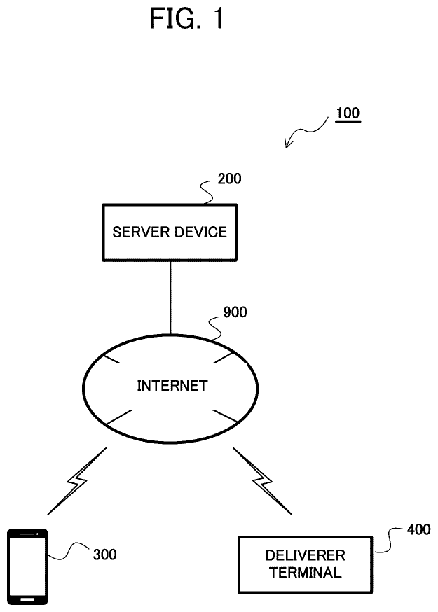

As illustrated in FIG. 1, a delivery status display system 100 according to Embodiment 1 of the present disclosure includes a server device 200 controlling the entire delivery status display system 100, a user terminal 300 being used by a user, a deliverer terminal 400 being used by a deliverer, and an internet 900 through which the server device 200, the user terminal 300, and the deliverer terminal 400 are connected to one another. Note that, it is assumed that the multiple user terminals 300 are present according to users who use the system, although simplified in the drawing. Further, it is assumed that the multiple deliverer terminals 400 are also present according to deliverers who deliver an item.

The server device 200 is, for example, a computer or the like for a server, and presents a delivery status of an item purchased by a user at an online grocer on the user terminal 300 of the user.

The user terminal 300 is, for example, a smartphone, a tablet, a personal computer, or the like being used by a user who uses an online grocer, and performs necessary communication with the server device 200.

For example, the user terminal 300 transmits inquiry information to the server device 200 for inquiring about a delivery status of an item purchased by a user. Then, the user terminal 300 receives response information sent from the server device 200, and displays the response information on a screen. Note that, a detail of the response information is described later.

The deliverer terminal 400 is, for example, a smartphone, a tablet, or the like being used by a deliverer who delivers an item purchased by a user to a user's home, and performs necessary communication with the server device 200.

For example, the deliverer terminal 400 includes a GPS signal receiver capable of receiving a GPS signal sent from a plurality of global positioning system (GPS) satellites, and transmits a current location (location information) of the deliverer terminal 400 to the server device 200 in response to a request from the server device 200.

Note that, instead of using such a GPS signal, the deliverer terminal 400 may use, for example, radio wave strength (receiving strength or the like) from a plurality of base stations to position a current location of the deliverer terminal 400, and may transmit the current location to the server device 200 in response to a request from the server device 200.

### (Summary Configuration of Information Processing Device)

A typical information processing device 500 achieving the server device 200, the user terminal 300, and the like according to the embodiment of the present disclosure is described.

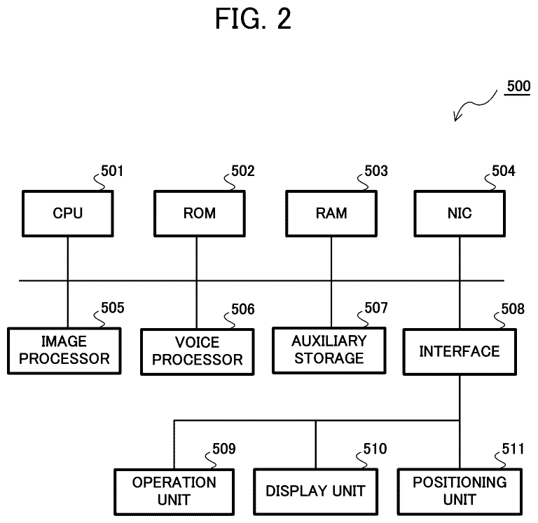

As illustrated in FIG. 2, the information processing device 500 includes a central processing unit (CPU) 501, a read only memory (ROM) 502, a random access memory (RAM) 503, a network interface card (NIC) 504, an image processor 505, a voice processor 506, an auxiliary storage 507, an interface 508, an operation unit 509, a display unit 510, and a positioning unit 511.

The CPU 501 controls an operation of the entire information processing device 500, is connected to each of the components, and exchanges a control signal or data therewith.

The ROM 502 records an initial program loader (IPL) that is executed immediately after power-on, and, when the initial program loader is executed, a program stored in the auxiliary storage 507 is read into the RAM 503 and execution of the program by the CPU 501 is started.

The RAM 503 is for temporarily storing data or a program, and holds a program or data read out from the auxiliary storage 507, as well as other data or the like necessary for communication.

The NIC 504 is for connecting the information processing device 500 to a computer communication network such as the internet, and includes one conforming to the 10BASE-T/100BASE-T standard for use in configuring a local area network (LAN), an analog modem for connecting to the internet by using a telephone line, an integrated services digital network (ISDN) modem, an asymmetric digital subscriber line (ADSL) modem, a cable modem for connecting to the internet by using a cable television line, and the like.

The image processor 505 processes, by using an image arithmetic processor (not illustrated) included in the CPU 501 or the image processor 505, image data read out from the auxiliary storage 507 or the like, and thereafter records the processed image data in a frame memory (not illustrated) included in the image processor 505. Image information recorded in the frame memory is converted into a video signal at predetermined synchronization timing, and the video signal is output to outside via the interface 508 or the like. Note that, when the information processing device 500 internally includes a display device (the display unit 510), the image processor 505 outputs the converted video signal to the display device. In other words, under control of the CPU 501, the image processor 505 generates an image needed in the progress of processing performed by the information processing device 500, and displays the image on the internal or external display device.

The voice processor 506 converts music data or voice data read out from the auxiliary storage 507 or the like into a voice signal, and outputs the voice signal to outside via the interface 508 or the like. Note that, when the information processing device 500 internally includes a speaker, the voice processor 506 outputs the converted voice signal to the speaker. In other words, under control of the CPU 501, the voice processor 506 generates a musical sound or a voice to be generated in the progress of processing performed by the information processing device 500, and outputs the musical sound or the like from the internal or external speaker.

The auxiliary storage 507 is a hard disk, a solid state drive (SSD), or the like, and stores various types of programs or various types of data needed for controlling an operation of the entire information processing device 500. For example, the auxiliary storage 507 stores a program for achieving the server device 200, the user terminal 300, and the like according to the embodiment. Then, by control of the CPU 501, the auxiliary storage 507 reads out the stored program or data as appropriate, and temporarily stores the program or data in the RAM 503 or the like.

The interface 508 conforms to, for example, a standard such as an HDMI (registered trademark), a universal serial bus (USB), an inter-integrated circuit (I2C), or the like, and, for example, the operation unit 509, the display unit 510, and the positioning unit 511 are connected thereto. Note that, the interface 508 may transmit and receive necessary information to and from external equipment connected thereto besides the above.

The operation unit 509 accepts an operation input of a worker or the like who uses the information processing device 500.

The display unit 510 draws an image according to image data output by the image processor 505, and presents the image to a worker or the like who uses the information processing device 500.

The positioning unit 511 receives, for example, a GPS signal sent from a plurality of GPS satellites, and positions a current location of the information processing device 500 at each predetermined timing.

Note that, instead of using such a GPS signal, the positioning unit 511 may use radio wave strength (receiving strength or the like) from a plurality of base stations to position a current location of the information processing device 500.

Besides the above, the information processing device 500 may include a drive unit for a digital versatile disc (DVD)-ROM or the like, instead of the auxiliary storage 507. In this case, the information processing device 500 reads out a program or data from the DVD-ROM or the like loaded into the drive unit, and operates similarly to the above.

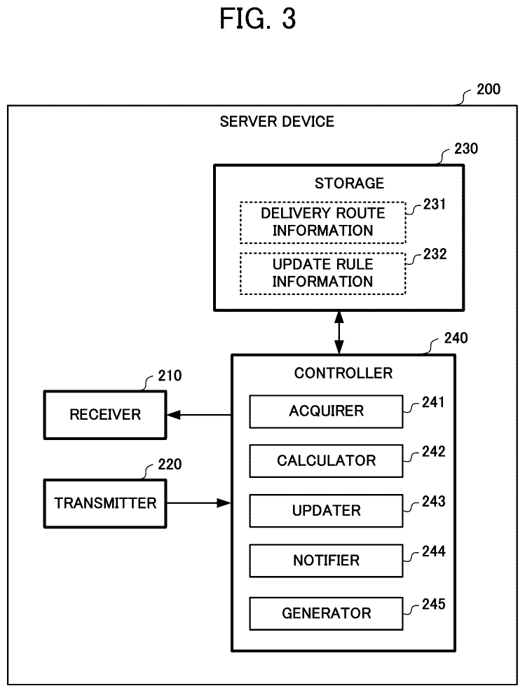

Hereinafter, a functional configuration or the like of the server device 200 achieved by the above-described information processing device 500 is described with reference to FIGS. 3 to 6. When the information processing device 500 is powered on and is enabled to communicate with, for example, the user terminal 300 and the deliverer terminal 400, a program causing the information processing device 500 to function as the server device 200 according to Embodiment 1 is executed, and the server device 200 according to Embodiment 1 is achieved.

### (Functional Configuration of Server Device 200)

FIG. 3 is a block diagram illustrating one example of a functional configuration of the server device 200 according to Embodiment 1. As illustrated, the server device 200 includes a receiver 210, a transmitter 220, a storage 230, and a controller 240.

The receiver 210 receives various pieces of information sent from the user terminal 300 or the deliverer terminal 400 via the internet 900.

For example, the receiver 210 is controlled by the controller 240 (more specifically, an acquirer 241 to be described later), and receives a current location from the deliverer terminal 400.

Further, the receiver 210 receives inquiry information about a delivery status from the user terminal 300 of a user being a delivery destination of an item.

Note that, the above-described NIC 504 may function as the receiver 210 as the above.

The transmitter 220 transmits, for example, various pieces of information addressed to the user terminal 300 or the like via the internet 900.

For example, the transmitter 220 is controlled by the controller 240 (more specifically, a notifier 244 to be described later), and gives, by means of push notification, advance notice information to the user terminal 300 of a user having an upcoming delivery.

Further, the transmitter 220 is controlled by the controller 240 (more specifically, a generator 245 to be described later), and transmits response information to be described later to the user terminal 300.

Note that, the above-described NIC 504 may function as the transmitter 220 as the above.

The storage 230 stores various pieces of information necessary for various types of processing in the server device 200. For example, the storage 230 stores delivery route information 231 and update rule information 232.

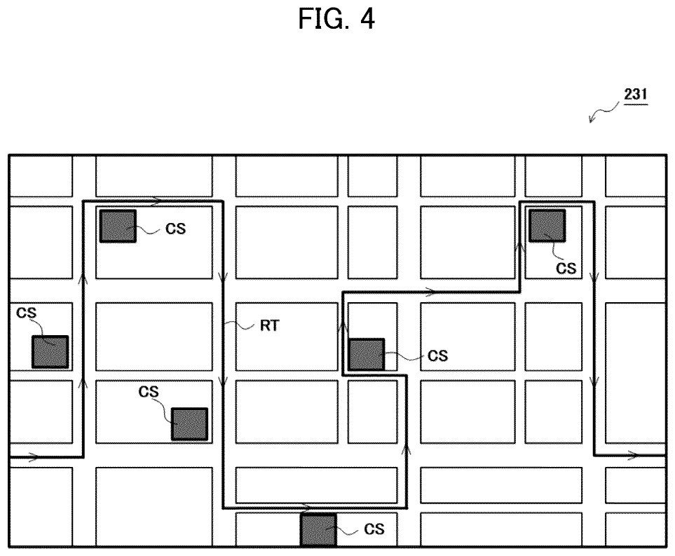

Specifically, the storage 230 stores, as one example, the delivery route information 231 as illustrated in FIG. 4.

Note that, the delivery route information 231 illustrated in FIG. 4 is an intelligible schematic representation of a delivery route RT and delivery destinations CS (user's homes) on the route, and, in practice, it is assumed that, for example, information on nodes and links defining the delivery route RT, location information of each of the delivery destinations CS, and the like are defined. Further, it is assumed that, for example, user information, item information, and delivery management information are associated with each of the delivery destinations CS.

The user information includes, for example, a user's name, specific information of the user terminal 300 used in push notification, a building classification (a house, an apartment complex, or the like) of a user's home, and the like.

Further, the item information includes, for example, an invoice number (slip number) and description of an item to be delivered.

Then, the delivery management information includes, for example, management information (as one example, delivery in progress, delivery completed, missed delivery, or the like) about delivery of an item.

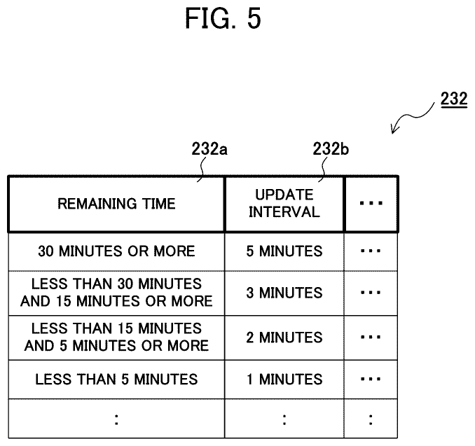

Further, the storage 230 stores, as one example, the update rule information 232 as illustrated in FIG. 5.

As illustrated in FIG. 5, the update rule information 232 includes, as one example, a remaining time 232a and an update interval 232b.

The remaining time 232a is information that defines ranges of time remaining until an estimated time of delivery calculated by the controller 240 (more specifically, a calculator 242 to be described later), and is associated with the update interval 232b.

Further, the update interval 232b defines an interval (update timing) at which a current location of the deliverer terminal 400 and an estimated time of delivery to each of the delivery destinations CS are updated by the controller 240 (more specifically, an updater 243 to be described later).

Besides the above, the storage 230 stores a current location of the deliverer terminal 400 acquired by the controller 240 (more specifically, an acquirer 241 to be described later) and an estimated time of delivery to each of the delivery destinations CS (user's homes) calculated by the controller 240 (more specifically, the calculator 242 to be described later).

Further, the storage 230 also stores information associating a user (the user terminal 300) with a deliverer (the deliverer terminal 400) and various types of images or text data constituting response information to be described later.

Note that, the above-described auxiliary storage 507 or the like may function as the storage 230 as the above.

Returning to FIG. 3, the controller 240 controls the entire server device 200. The controller 240 includes, for example, the acquirer 241, the calculator 242, the updater 243, the notifier 244, and the generator 245.

The acquirer 241 acquires a current location from the deliverer terminal 400 being used by a deliverer who delivers an item to a user.

For example, the acquirer 241 acquires a current location of the deliverer terminal 400 by requesting, through control of the transmitter 220, the deliverer terminal 400 to transmit a current location, and receiving, by the receiver 210, the current location sent in response thereto from the deliverer terminal 400. Note that, timing at which the acquirer 241 acquires a current location from the deliverer terminal 400 is controlled by the updater 243 to be described later.

The calculator 242 calculates, based on the above-described current location acquired by the acquirer 241 and the above-described delivery route information 231 as illustrated in FIG. 4, an estimated time of delivery at which a deliverer is expected to be able to make a delivery to a user's home.

In other words, the calculator 242 calculates an estimated time of delivery to each of the delivery destinations CS (user's homes). Note that, it is assumed that each time delivery by a deliverer proceeds and there arise a delivery destination CS where a delivery has been completed and a delivery destination CS where a user has been absent, the calculator 242 excludes the delivery destinations CS and calculates an estimated time of delivery for a remaining delivery destination CS.

Further, the calculator 242 may calculate an estimated time of delivery by specifying, based on the delivery route information 231, the number of other delivery destinations between the current location and a user's home or a building classification as for the other delivery destinations and the user's home, and further adding time required according to the specified number of the other delivery destinations or the building classification.

Further, timing at which the calculator 242 calculates an estimated time of delivery to each of the delivery destinations CS is controlled by the updater 243 to be described later.

The updater 243 controls the above-described acquirer 241 and the above-described calculator 242 to update a current location and an estimated time of delivery at each predetermined time interval.

For example, among the delivery destinations CS for which the calculator 242 has calculated an estimated time of delivery, the updater 243 determines to which of the remaining time 232a in the update rule information 232 illustrated in FIG. 5, time remaining until the estimated time of delivery to a next delivery destination CS belongs, and sets the update interval 232b associated therewith as next update timing.

In other words, the updater 243 changes a time interval according to length of time remaining until an estimated time of delivery, and updates a current location and the estimated time of delivery.

The notifier 244 notifies the user terminal 300 of advance notice information that a delivery is about to be made soon when time remaining until the estimated time of delivery calculated by the calculator 242 described above goes below a predetermined threshold value.

For example, when, among the delivery destinations CS for which the calculator 242 has calculated an estimated time of delivery, there is any delivery destination CS at which time remaining until the estimated time of delivery goes below a threshold value (as one example, thirty minutes), the notifier 244 gives, by means of push notification, advance notice information to the user terminal 300 being used by a user at the delivery destination CS.

Note that, it is assumed that the notifier 244 excludes the delivery destination CS (the user terminal 300) to which advance notice information has been already given, and gives advance notice information only for the delivery destination CS (the user terminal 300) at which time remaining goes below a threshold value for the first time.

The generator 245 generates, in response to inquiry information received by the above-described receiver 210 from the user terminal 300, response information including a current location of the deliverer terminal 400 and an estimated time of delivery. Then, the generator 245 controls the above-described transmitter 220 to transmit the generated response information to the inquiring user terminal 300.

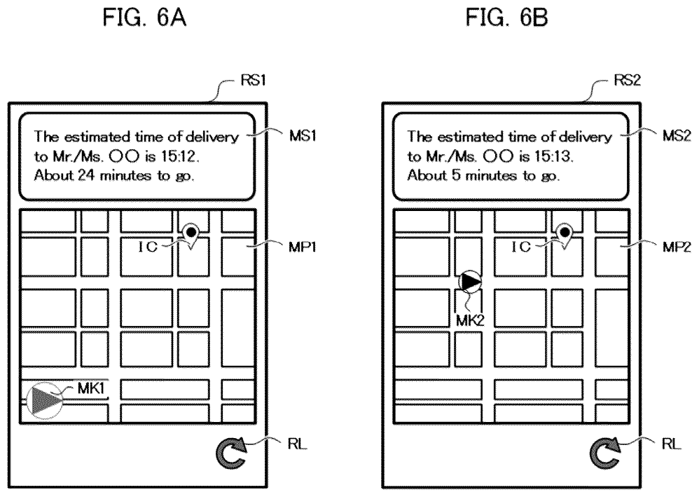

For example, the generator 245 generates response information RS1 as illustrated in FIG. 6A. The response information RS1 includes a message MS1, a map image MP1, and a reload symbol RL.

The message MS1 includes, for example, a text indicating an estimated time of delivery and time remaining until the estimated time of delivery. Note that, the message MS1 may include any one of an estimated time of delivery and remaining time.

Further, the map image MP1 includes a marker MK1 indicating a current location of the deliverer terminal 400 and an icon IC indicating a location of a user's home, the marker MK1 and the icon IC being superimposed on a map. Note that, the generator 245 may change a form (for example, size, color, or the like) of the marker MK1 according to length of time remaining until the estimated time of delivery. For example, in a case of FIG. 6A, since time remaining until the estimated time of delivery is long, the generator 245 generates the light-colored marker MK1 larger than standard, and superimposes the marker MK1 on the map.

Further, the reload symbol RL is a symbol for reloading the response information RS1. In other words, when the response information RS1 is sent to the user terminal 300 and displayed, and the reload symbol RL is operated (touched or the like) by a user, inquiry information is transmitted to the server device 200.

Note that, even when the reload symbol RL as the above is operated on the user terminal 300, the generator 245 generates the response information RS1, based on the current location and the estimated time of delivery acquired and calculated at most recent update timing, since the acquirer 241 and the calculator 242 are controlled by the updater 243, as described above. In other words, the generator 245 generates the response information RS1 in which only the remaining time in the message MS1 is changed (when more than 1 minute of time has elapsed).

Furthermore, when the message MS1 includes only the estimated time of delivery (that is, when including no remaining time), the generator 245 may save the generated response information RS1 once in the storage 230, and may read out the saved response information RS1 and transmit the response information RS1 as is to the user terminal 300 until update timing of the updater 243 arrives.

Further, as delivery by a deliverer proceeds and the current location of the deliverer terminal 400 approaches the user's home (the icon IC), the generator 245 generates, for example, response information RS2 as illustrated in FIG. 6B. The response information RS2 includes a message MS2, a map image MP2, and a reload symbol RL.

The message MS2 includes, similarly, an estimated time of delivery and time remaining until the estimated time of delivery. Note that, the message MS2 may include any one of an estimated time of delivery and remaining time.

Further, the map image MP2 includes a marker MK2 indicating a current location of the deliverer terminal 400 and an icon IC indicating a location of a user's home, the marker MK2 and the icon IC being superimposed on a map. Note that, the generator 245 may change a form of the marker MK2 according to length of time remaining until the estimated time of delivery. For example, in a case of FIG. 6B, since time remaining until the estimated time of delivery is short, the generator 245 generates the dark-colored marker MK2 as large as standard (smaller than the above-described marker MK1), and superimposes the marker MK2 on the map.

Then, the reload symbol RL is, similarly, a symbol for reloading the response information RS2.

Note that, the above-described CPU 501, the image processor 505, or the like may function as the controller 240 configured as the above.

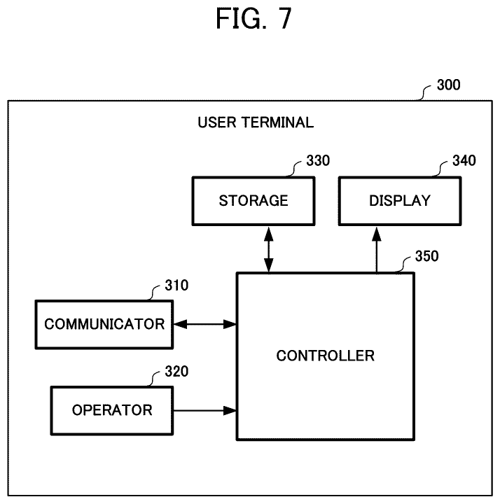

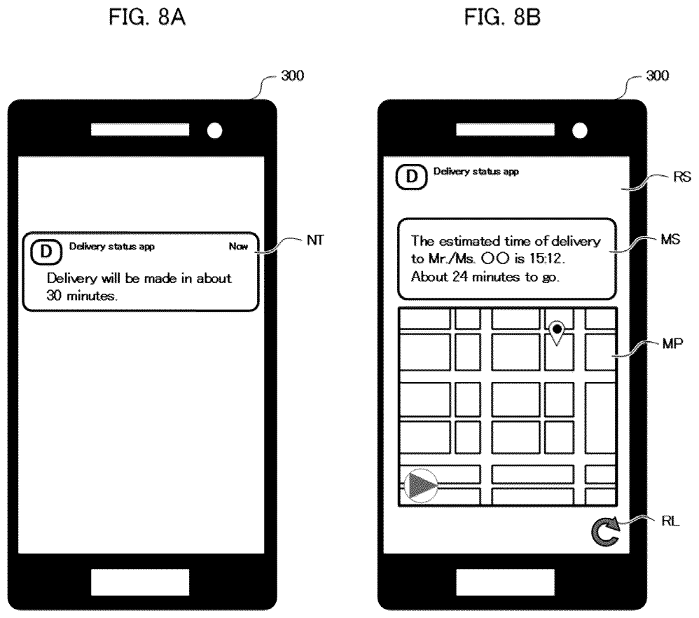

Next, a functional configuration or the like of the user terminal 300 achieved by the above-described information processing device 500 is described with reference to FIGS. 7 and 8A-8B. When the information processing device 500 is powered on and is enabled to communicate with, for example, the server device 200, a program causing the information processing device 500 to function as the user terminal 300 according to Embodiment 1 is executed, and the user terminal 300 according to Embodiment 1 is achieved.

### (Functional Configuration of User Terminal 300)

FIG. 7 is a block diagram illustrating one example of a functional configuration of the user terminal 300 according to Embodiment 1. As illustrated, the user terminal 300 includes a communicator 310, an operator 320, a storage 330, a display 340, and a controller 350.

The communicator 310 receives various types of information sent from the server device 200, and transmits various types of information to the server device 200.

For example, the communicator 310 receives advance notice information sent from the server device 200 by means of push notification and response information sent from the server device 200. Further, the communicator 310 transmits, for example, inquiry information or the like to the server device 200 in response to an operation of a user.

Note that, the above-described NIC 504 may function as the communicator 310 as the above.

The operator 320 is, for example, a touch panel (touch screen) or the like, and accepts various types of operations performed by a user.

For example, the operator 320 accepts an operation to a push notification (advance notice information) displayed on the display 340 or an operation to response information (a reload symbol or the like) displayed on the display 340.

Note that, the above-described operation unit 509 may function as the operator 320 as the above.

The storage 330 stores various pieces of information necessary for various types of processing in the user terminal 300. For example, the storage 330 stores user information about a user who uses the user terminal 300.

Note that, the above-described auxiliary storage 507 or the like may function as the storage 330 as the above.

The display 340 displays various pieces of information for a user.

For example, the display 340 displays advance notice information NT sent from the server device 200 by means of push notification, as illustrated in FIG. 8A. Note that, when the advance notice information NT is operated by a user, inquiry information is sent to the server device 200. Then, the display 340 displays response information RS sent in response thereto from the server device 200, as illustrated in FIG. 8B.

The response information RS includes a message MS, a map image MP, and a reload symbol RL, as described above. The response information RS as the above can be displayed on the display 340 also by, for example, a user inputting, on a predetermined inquiry screen, an invoice number (slip number) or the like of a purchased item, other than by a user operating the advance notice information NT as illustrated in FIG. 8A.

Further, when the reload symbol RL included in the response information RS is operated by a user, inquiry information is sent to the server device 200. Then, the display 340 displays the response information RS sent in response thereto from the server device 200.

Note that, the above-described display unit 510 may function as the display 340 as the above.

Returning to FIG. 7, the controller 350 controls the entire user terminal 300.

For example, when the communicator 310 receives a push notification from the server device 200, the controller 350 displays the above-described advance notice information NT as illustrated in FIG. 8A on the display 340. Further, when the advance notice information NT as illustrated in FIG. 8A is operated by a user, the controller 350 controls the communicator 310 to transmit inquiry information to the server device 200, and displays the response information RS sent in response thereto from the server device 200 on the display 340, as illustrated in FIG. 8B.

Furthermore, when the reload symbol RL included in the response information RS as illustrated in FIG. 8B is operated by a user, the controller 350 displays the response information RS sent in response thereto from the server device 200 on the display 340.

Note that, the above-described CPU 501, the image processor 505, or the like may function as the controller 350 as the above.

Further, the deliverer terminal 400 is also achieved similarly by the information processing device 500, but description therefor is omitted.

### (Operation of Server Device 200 and User Terminal 300)

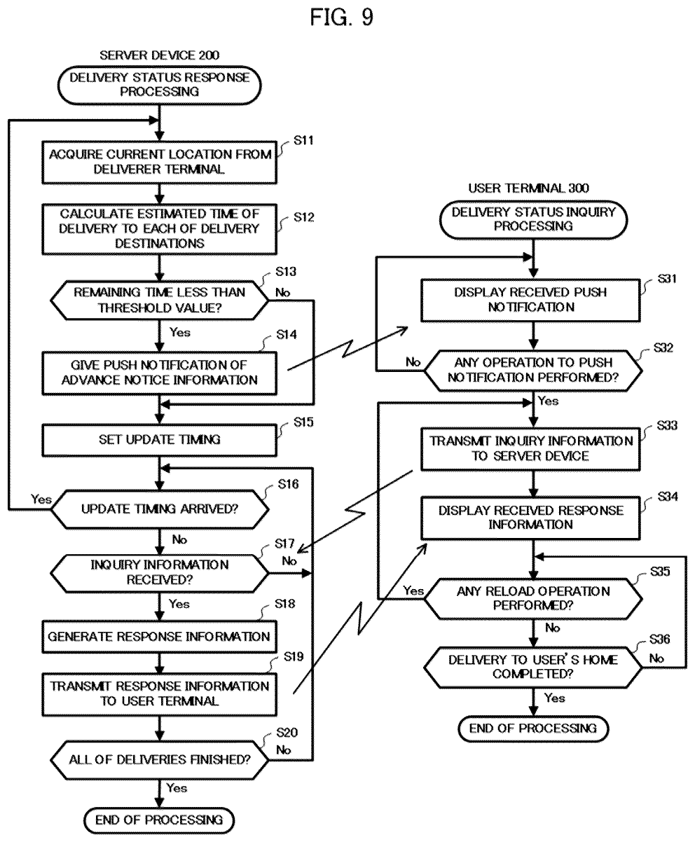

Hereinafter, an operation of the server device 200 and the user terminal 300 according to Embodiment 1 is described with reference to FIG. 9. FIG. 9 is a flowchart illustrating a flow of delivery status response processing executed by the server device 200 and delivery status inquiry processing executed by the user terminal 300.

Note that, the delivery status response processing is started, for example, in response to delivery start by a deliverer who uses the deliverer terminal 400. Further, the delivery status inquiry processing is started, for example, in response to a push notification from the server device 200.

First, the server device 200 acquires a current location from the deliverer terminal 400 (Step S11).

In other words, the controller 240 (the acquirer 241) acquires a current location from the deliverer terminal 400 being used by a deliverer who makes a delivery to each of the delivery destinations CS.

The server device 200 calculates an estimated time of delivery to each of the delivery destinations CS (Step S12).

In other words, the controller 240 (the calculator 242) calculates an estimated time of delivery to each of the delivery destinations CS, based on the current location of the deliverer terminal 400 acquired in Step S11 described above and the delivery route information 231 as illustrated in FIG. 4.

The server device 200 determines whether remaining time is less than a threshold value (Step S13).

In other words, the controller 240 (the notifier 244) determines whether, among the delivery destinations CS for which the estimated time of delivery has been calculated in Step S12 described above, there is any delivery destination at which time remaining until the estimated time of delivery goes below a threshold value (as one example, thirty minutes). Note that, it is assumed that the controller 240 excludes a delivery destination CS to which advance notice information has been already given, and determines whether there is any delivery destination CS at which remaining time goes below a threshold value for the first time.

When determining that remaining time is not less than a threshold value (Step S13; No), the server device 200 proceeds with the processing to Step S15 to be described later.

Meanwhile, when determining that remaining time is less than a threshold value (Step S13; Yes), the server device 200 gives a push notification of advance notice information (Step S14).

In other words, the controller 240 (the notifier 244) controls the transmitter 220 to transmit, by means of push notification, advance notice information to the user terminal 300 of interest.

The user terminal 300 to which a push notification has been sent displays the received push notification (Step S31).

In other words, the controller 350 displays, for example, the advance notice information NT as illustrated in FIG. 8A on the display 340.

The user terminal 300 determines whether any operation to the push notification has been performed (Step S32).

When determining that no operation to the push notification has been performed (Step S32; No), the user terminal 300 returns the processing to Step S31 described above.

Returning to the server device 200—side flowchart, the server device 200 sets update timing (Step S15).

In other words, the controller 240 (the updater 243) refers to the update rule information 232 as illustrated in FIG. 5, and sets an update interval according to time remaining until the estimated time of delivery to a next delivery destination CS.

The server device 200 determines whether the update timing set in Step S15 described above has arrived (Step S16).

When determining that the update timing has arrived (Step S16; Yes), the server device 200 returns the processing to Step S11 described above.

Meanwhile, when determining that the update timing has not arrived (Step S16; No), the server device 200 determines whether inquiry information has been received (Step S17).

In other words, the controller 240 determines whether inquiry information sent from the user terminal 300 has been received.

When determining that inquiry information has not been received (Step S17; No), the server device 200 returns the processing to Step S16 described above.

Returning to the user terminal 300—side flowchart, when determining that an operation to the push notification has been performed in Step S32 described above (Step S32; Yes), the user terminal 300 transmits inquiry information to the server device 200 (Step S33).

Returning to the server device 200—side flowchart, when determining that inquiry information has been received in Step S17 described above (Step S17; Yes), the server device 200 generates response information (Step S18).

In other words, the controller 240 (the generator 245) generates, for example, the response information RS1 or RS2 as illustrated in FIG. 6A or 6B.

The server device 200 transmits the response information to the user terminal 300 (Step S19).

In other words, the controller 240 (the generator 245) transmits the response information generated in Step S18 described above to the inquiring user terminal 300.

Returning to the user terminal 300—side flowchart, the user terminal 300 displays the received response information (Step S34).

In other words, the controller 350 displays, for example, the response information RS as illustrated in FIG. 8B on the display 340.

The user terminal 300 determines whether any reload operation has been performed (Step S35).

In other words, the controller 350 determines whether the reload symbol RL in the response information RS as illustrated in FIG. 8B has been operated by a user.

When determining that a reload operation has been performed (Step S35; Yes), the user terminal 300 returns the processing to Step S33 described above.

Meanwhile, when determining that no reload operation has been performed (Step S35; No), the user terminal 300 determines whether a delivery to a user's home has been completed (Step S36).

For example, when delivery completion information for informing completion of a delivery is sent from the server device 200 and the delivery completion information is received by the communicator 310, the controller 350 determines that a delivery to a user's home has been completed.

When determining that a delivery to a user's home has not been completed (Step S36; No), the user terminal 300 returns the processing to Step S35 described above.

Meanwhile, when determining that a delivery to a user's home has been completed (Step S36; Yes), the user terminal 300 ends the delivery status inquiry processing.

Returning to the server device 200—side flowchart, the server device 200 determines whether all of deliveries have been finished (Step S20).

In other words, the controller 240 determines whether all of deliveries to the delivery destinations CS assigned to the deliverer have been finished. Note that, even when the user is not at home at a time of delivery, the delivery to the delivery destination CS is determined as finished.

When determining that not all of deliveries have been finished (Step S20; No), the server device 200 returns the processing to Step S16 described above.

Meanwhile, when determining that all of deliveries have been finished (Step S20; Yes), the server device 200 ends the delivery status response processing.

Through the delivery status response processing and the delivery status inquiry processing illustrated in FIG. 9 as the above, timing of acquiring a current location from the deliverer terminal 400 and timing of calculating an estimated time of delivery to each delivery destination are controlled on the server device 200 side. This can prevent increase in load (communication load or processing load) on the server device 200, even when inquiry information is sent frequently from the user terminal 300 to the server device 200.

As a result, a delivery status can be presented to a user intelligibly while preventing increase in load.

In Embodiment 1 described above, a case in which update timing (timing of acquiring a current location from the deliverer terminal 400 and timing of calculating an estimated time of delivery to each delivery destination) is controlled on the server device 200 side has been described. However, the update timing may be controlled on the user terminal 300 side.

### Embodiment 2

Hereinafter, a delivery status display system 100 according to Embodiment 2 of the present disclosure in which update timing is controlled on a user terminal 300 side is described. Note that, an overall configuration of the delivery status display system 100 according to Embodiment 2 is the same as FIG. 1.

### (Functional Configuration of Server Device 200)

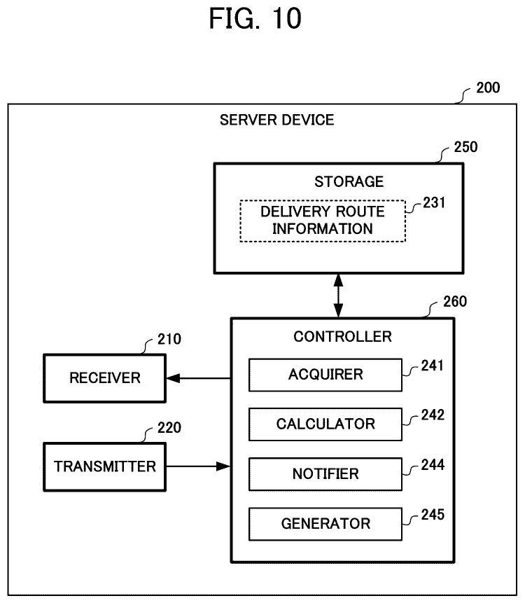

FIG. 10 is a block diagram illustrating one example of a functional configuration of a server device 200 according to Embodiment 2. As illustrated, the server device 200 includes a receiver 210, a transmitter 220, a storage 250, and a controller 260.

Note that, the receiver 210 and the transmitter 220 have the same configuration as the server device 200 in FIG. 3 described above.

The storage 250 stores various pieces of information necessary for various types of processing in the server device 200. For example, the storage 230 stores delivery route information 231.

In other words, the storage 250 has the configuration of the storage 230 in the server device 200 in FIG. 3 from which the update rule information 232 is deleted.

Note that, the delivery route information 231 is the same as the content described with reference to FIG. 4 described above.

The controller 260 controls the entire server device 200. The controller 260 includes, for example, an acquirer 241, a calculator 242, a notifier 244, and a generator 245.

In other words, the controller 260 has the configuration of the controller 240 in the server device 200 in FIG. 3 from which the updater 243 is deleted.

The acquirer 241, the calculator 242, the notifier 244, and the generator 245 are the same as the configuration of the controller 240 in the server device 200 in FIG. 3. Nevertheless, the acquirer 241, the calculator 242, and the generator 245 are slightly different from the server device 200 in FIG. 3.

The acquirer 241 acquires a current location from a deliverer terminal 400 in response to inquiry information received by the receiver 210.

When a current location is acquired by the acquirer 241, the calculator 242 calculates, based on the acquired current location and the delivery route information 231 stored in the storage 250, an estimated time of delivery at which a deliverer is expected to be able to make a delivery to a user's home.

When an estimated time of delivery is calculated by the calculator 242, the generator 245 generates response information including the current location and the estimated time of delivery.

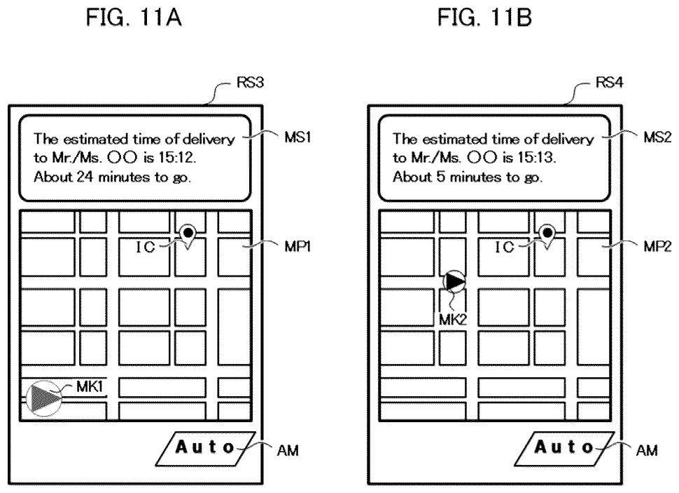

For example, the generator 245 generates response information RS3 as illustrated in FIG. 11A. The response information RS3 includes a message MS1, a map image MP1, and an auto mark AM.

The message MS1 and the map image MP1 are the same as the response information RS1 in FIG. 6A described above.

Further, the auto mark AM is a mark indicating automatic update. In other words, the response information RS3 includes the auto mark AM instead of the reload symbol RL in the response information RS1 in FIG. 6A.

Further, as delivery by a deliverer proceeds and the current location of the deliverer terminal 400 approaches the user's home (an icon IC), the generator 245 generates, for example, response information RS4 as illustrated in FIG. 11B. The response information RS4 includes a message MS2, a map image MP2, and an auto mark AM.

The message MS2 and the map image MP2 are the same as the response information RS2 in FIG. 6B described above.

Further, the auto mark AM is a mark indicating automatic update. In other words, the response information RS4 includes the auto mark AM instead of the reload symbol RL in the response information RS2 in FIG. 6B.

### (Functional Configuration of User Terminal 300)

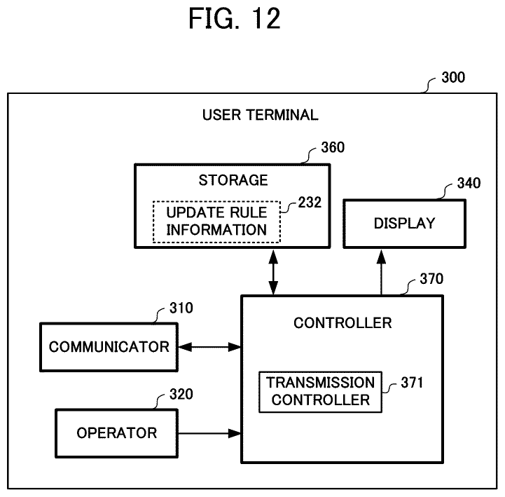

FIG. 12 is a block diagram illustrating one example of a functional configuration of a user terminal 300 according to Embodiment 2. As illustrated, the user terminal 300 includes a communicator 310, an operator 320, a storage 360, a display 340, and a controller 370.

Note that, the communicator 310, the operator 320, and the display 340 have the same configuration as the user terminal 300 in FIG. 7 described above.

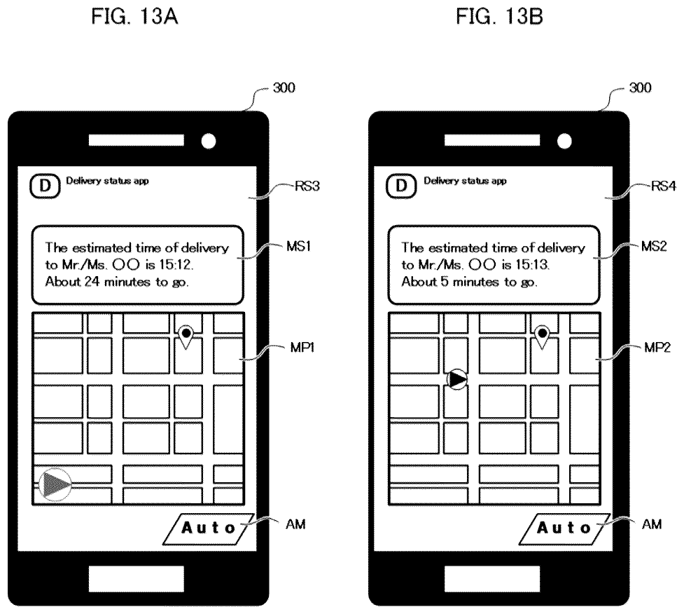

Nevertheless, the display 340 displays the response information RS3 or RS4 generated by the generator 245 in the server device 200 and sent therefrom, as illustrated in FIG. 13A or 13B.

Returning to FIG. 12, the storage 360 stores various pieces of information necessary for various types of processing in the user terminal 300. For example, the storage 360 stores update rule information 232.

In other words, the storage 360 stores the update rule information 232 as illustrated in FIG. 5 described above.

The controller 370 controls the entire user terminal 300. The controller 370 includes, for example, a transmission controller 371.

The transmission controller 371 causes inquiry information to be transmitted at each predetermined time interval.

For example, the transmission controller 371 determines to which of a remaining time 232a in the update rule information 232, remaining time in the message (the message MS1, MS2, or the like) included in the response information (the response information RS3, RS4, or the like illustrated in FIGS. 13A-13B) sent from the server device 200 belongs, and sets an update interval 232b associated therewith as next transmission timing of inquiry information.

In other words, the transmission controller 371 changes a time interval according to length of time remaining until the estimated time of delivery included in the response information, and causes inquiry information to be transmitted to the server device 200.

### (Operation of Server Device 200 and User Terminal 300)

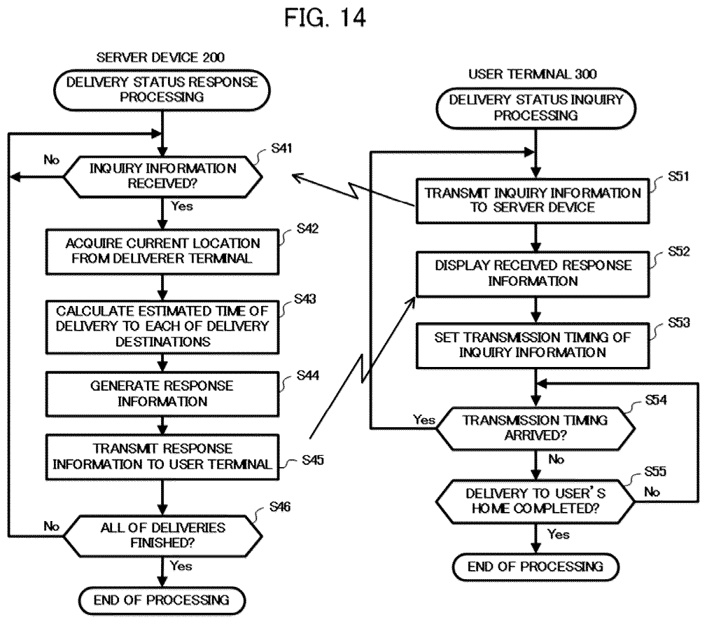

Hereinafter, an operation of the server device 200 and the user terminal 300 according to Embodiment 2 is described with reference to FIG. 14. FIG. 14 is a flowchart illustrating a flow of delivery status response processing executed by the server device 200 and delivery status inquiry processing executed by the user terminal 300.

Note that, the delivery status response processing is started, for example, in response to delivery start by a deliverer who uses the deliverer terminal 400. Further, the delivery status inquiry processing is started, for example, in response to a push notification from the server device 200, but processing about the push notification is omitted (the same applies to the delivery status response processing).

First, the server device 200 determines whether any inquiry information sent from the user terminal 300 has been received (Step S41).

When determining that no inquiry information has been received (Step S41; No), the server device 200 continues to wait for reception of inquiry information.

Moving to the user terminal 300—side flowchart, the user terminal 300 transmits inquiry information to the server device 200 (Step S51).

For example, the controller 370 transmits inquiry information to the server device 200 only at the first time advance notice information sent by means of push notification from the server device 200 is operated by a user.

Returning to the server device 200—side flowchart, when determining that inquiry information has been received in Step S41 described above (Step S41; Yes), the server device 200 acquires a current location from the deliverer terminal 400 (Step S42).

In other words, the controller 260 (the acquirer 241) acquires a current location from the deliverer terminal 400 being used by a deliverer.

The server device 200 calculates an estimated time of delivery to each of delivery destinations CS (Step S43).

In other words, the controller 260 (the calculator 242) calculates an estimated time of delivery to each of the delivery destinations CS, based on the current location of the deliverer terminal 400 acquired in Step S42 described above and the delivery route information 231.

Note that, the controller 260 may calculate only an estimated time of delivery to the delivery destination CS of the user terminal 300 having sent inquiry information.

The server device 200 generates response information (Step S44).

In other words, the controller 260 (the generator 245) generates, for example, the response information RS3 or RS4 as illustrated in FIG. 11A or 11B.

The server device 200 transmits the response information to the user terminal 300 (Step S45).

In other words, the controller 260 (the generator 245) transmits the response information generated in Step S44 described above to the inquiring user terminal 300.

Returning to the user terminal 300—side flowchart, the user terminal 300 displays the received response information (Step S52).

In other words, the controller 370 displays, for example, the response information RS (RS3 or RS4) as illustrated in FIG. 13A or 13B on the display 340.

The user terminal 300 sets transmission timing of inquiry information (Step S53).

In other words, the controller 370 (the transmission controller 371) determines to which of the remaining time 232a in the update rule information 232, remaining time in the message (the message MS1, MS2, or the like) included in the response information (the response information RS3, RS4, or the like illustrated in FIGS. 13A-13B) belongs, and sets the update interval 232b associated therewith as next transmission timing of inquiry information.

The user terminal 300 determines whether the transmission timing set in Step S53 described above has arrived (Step S54).

When determining that the transmission timing has arrived (Step S54; Yes), the user terminal 300 returns the processing to Step S51 described above.

Meanwhile, when determining that the transmission timing has not arrived (Step S54; No), the user terminal 300 determines whether a delivery to a user's home has been completed (Step S55).

For example, when delivery completion information for informing completion of a delivery is sent from the server device 200 and the delivery completion information is received by the communicator 310, the controller 370 determines that a delivery to a user's home has been completed.

When determining that a delivery to a user's home has not been completed (Step S55; No), the user terminal 300 returns the processing to Step S54 described above.

Meanwhile, when determining that a delivery to a user's home has been completed (Step S55; Yes), the user terminal 300 ends the delivery status inquiry processing.

Returning to the server device 200—side flowchart, the server device 200 determines whether all of deliveries have been finished (Step S46).

In other words, the controller 260 determines whether all of deliveries to the delivery destinations CS assigned to the deliverer have been finished. Note that, even when the user is not at home at a time of delivery, the delivery to the delivery destination CS is determined as finished.

When determining that not all of deliveries have been finished (Step S46; No), the server device 200 returns the processing to Step S41 described above.

Meanwhile, when determining that all of deliveries have been finished (Step S46; Yes), the server device 200 ends the delivery status response processing.

In the delivery status response processing and the delivery status inquiry processing illustrated in FIG. 14 as the above, update timing (timing of acquiring a current location from the deliverer terminal 400 and timing of calculating an estimated time of delivery to each delivery destination) is controlled on the user terminal 300 side. At that time, automatic update is performed by the user terminal 300 side at appropriate intervals, which can prevent increase in load (communication load or processing load) on the server device 200.

As a result, a delivery status can be presented to a user intelligibly while preventing increase in load.

In Embodiment 1 or 2 described above, a case in which the controller 240 or 260 (the generator 245) in the server device 200 unconditionally generates response information including a map image has been described. However, from a point of view of protecting privacy of other users, response information including a map image may be generated only when there is no other delivery destination between a current location of the deliverer terminal 400 and a user's home.

### Embodiment 3

Hereinafter, a delivery status display system 100 according to Embodiment 3 of the present disclosure in which privacy-protected response information is generated is described. Note that, an overall configuration of the delivery status display system 100 according to Embodiment 3 is the same as FIG. 1.

Further, in the delivery status display system 100 according to Embodiment 3, a case in which update timing (timing of acquiring a current location from a deliverer terminal 400 and timing of calculating an estimated time of delivery to each delivery destination) is controlled on a server device 200 side is described, similarly to Embodiment 1. However, the delivery status display system 100 according to Embodiment 3 is also applicable to a case in which update timing is controlled on a user terminal 300 side, similarly to Embodiment 2.

### (Functional Configuration of Server Device 200)

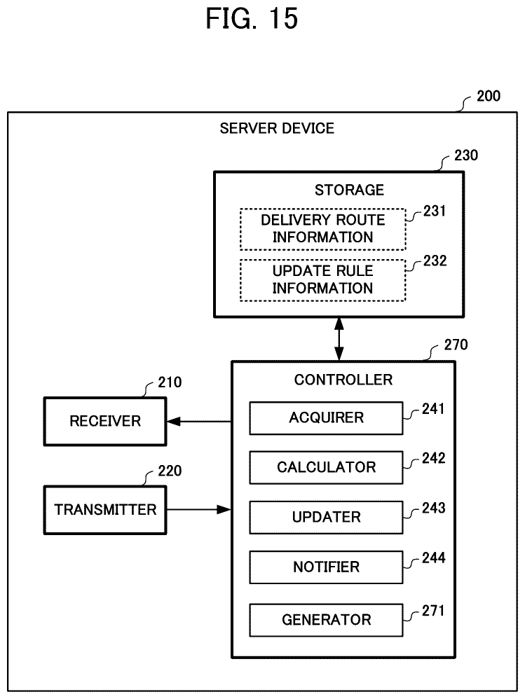

FIG. 15 is a block diagram illustrating one example of a functional configuration of a server device 200 according to Embodiment 3. As illustrated, the server device 200 includes a receiver 210, a transmitter 220, a storage 230, and a controller 270.

Note that, the receiver 210, the transmitter 220, and the storage 230 have the same configuration as the server device 200 in FIG. 3 described above.

The controller 270 controls the entire server device 200. The controller 270 includes, for example, an acquirer 241, a calculator 242, an updater 243, a notifier 244, and a generator 271.

In other words, the controller 270 includes the generator 271 instead of the generator 245 in the controller 240 illustrated in FIG. 3.

The acquirer 241, the calculator 242, the updater 243, and the notifier 244 are the same as the configuration of the controller 240 in the server device 200 in FIG. 3.

The generator 271 generates, in response to inquiry information received by the receiver 210 from a user terminal 300, response information including at least an estimated time of delivery. Then, the generator 271 controls the transmitter 220 to transmit the generated response information to the inquiring user terminal 300.

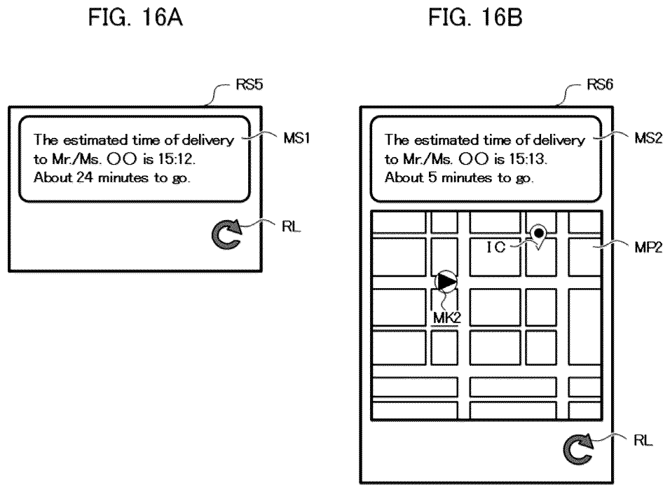

For example, the generator 271 generates response information RS5 as illustrated in FIG. 16A when there is another delivery destination between a current location of the deliverer terminal 400 and a user's home. The response information RS5 includes a message MS1 and a reload symbol RL. In other words, the generator 271 generates the response information RS5 excluding a map image when there is another delivery destination between a current location of the deliverer terminal 400 and a user's home.

Meanwhile, the generator 271 generates, for example, response information RS6 as illustrated in FIG. 16B when there is no other delivery destination between a current location of the deliverer terminal 400 and a user's home. The response information RS6 includes a message MS2, a map image MP2, and a reload symbol RL.

In other words, the generator 271 generates response information including a map image only when there is no other delivery destination between a current location of the deliverer terminal 400 and a user's home.

Note that, a functional configuration of the user terminal 300 is the same as FIG. 7, and thus, description therefor is omitted.

### (Operation of Server Device 200)

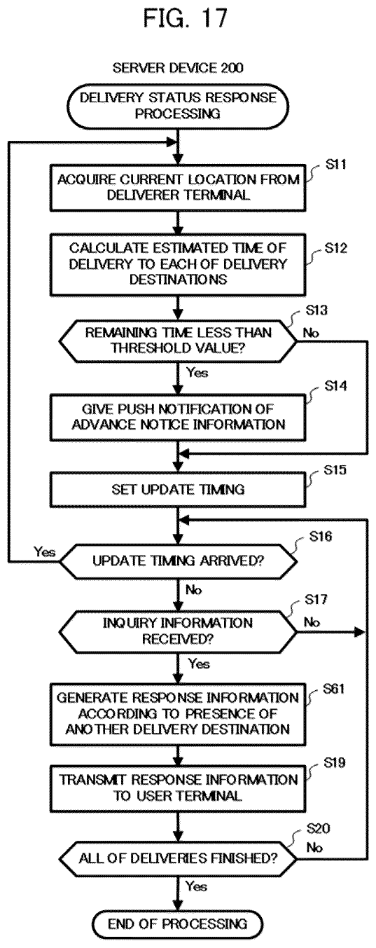

Hereinafter, an operation of the server device 200 according to Embodiment 3 is described with reference to FIG. 17. FIG. 17 is a flowchart illustrating a flow of delivery status response processing executed by the server device 200 and delivery status inquiry processing executed by the user terminal 300. Note that, an operation on the user terminal 300 side is the same as the delivery status inquiry processing in FIG. 9, and thus, description therefor is omitted.

Further, in the delivery status response processing in FIG. 17, processing same as the delivery status response processing in FIG. 9 is assigned with the same reference sign. Hereinafter, the same processing is described simply.

First, the server device 200 acquires a current location from the deliverer terminal 400 (Step S11), and calculates an estimated time of delivery to each of delivery destinations CS (Step S12).

The server device 200 determines whether remaining time is less than a threshold value (Step S13), and, when determining that remaining time is not less than a threshold value (Step S13; No), the server device 200 proceeds with the processing to Step S15 to be described later.

Meanwhile, when determining that remaining time is less than a threshold value (Step S13; Yes), the server device 200 gives a push notification of advance notice information (Step S14).

The server device 200 sets update timing (Step S15), and determines whether the update timing has arrived (Step S16).

When determining that the update timing has arrived (Step S16; Yes), the server device 200 returns the processing to Step S11 described above.

Meanwhile, when determining that the update timing has not arrived (Step S16; No), the server device 200 determines whether inquiry information has been received (Step S17), and, when determining that inquiry information has not been received (Step S17; No), the server device 200 returns the processing to Step S16 described above.

Meanwhile, when determining that inquiry information has been received (Step S17; Yes), the server device 200 generates response information according to presence of another delivery destination (Step S61).

In other words, the controller 270 (generator 271) generates, for example, the response information RS5 as illustrated in FIG. 16A when there is another delivery destination between a current location of the deliverer terminal 400 and a user's home. The response information RS5 includes a message MS1 and a reload symbol RL. In other words, the controller 270 generates the response information RS5 excluding a map image when there is another delivery destination between a current location of the deliverer terminal 400 and a user's home.

Meanwhile, the controller 270 generates, for example, the response information RS6 as illustrated in FIG. 16B when there is no other delivery destination between a current location of the deliverer terminal 400 and a user's home. The response information RS6 includes a message MS2, a map image MP2, and a reload symbol RL.

In other words, the controller 270 generates response information including a map image only when there is no other delivery destination between a current location of the deliverer terminal 400 and a user's home.

The server device 200 transmits the response information to the user terminal 300 (Step S19).

In other words, the controller 270 (the generator 271) transmits the response information generated in Step S61 described above to the inquiring user terminal 300.

The server device 200 determines whether all of deliveries have been finished (Step S20), and, when determining that not all of deliveries have been finished (Step S20; No), the server device 200 returns the processing to Step S16 described above.

Meanwhile, when determining that all of deliveries have been finished (Step S20; Yes), the server device 200 ends the delivery status response processing.

Through the delivery status response processing illustrated in FIG. 17 as the above, response information including a map image is generated only when there is no other delivery destination between a current location of the deliverer terminal 400 and a user's home. This can prevent estimation of a delivery addressed to another user from a map image.

As a result, a delivery status can be presented to a user intelligibly while protecting privacy.

### Other Embodiments

In Embodiments 1 to 3 described above, a case in which an estimated time of delivery to each of the delivery destinations CS is calculated, by the calculator 24 in the server device 200, based on a current location of the deliverer terminal 400 and the delivery route information 231 as illustrated in FIG. 4 has been described. However, an estimated time of delivery may be calculated by adding another piece of information.

For example, each time the acquirer 241 acquires a current location from the deliverer terminal 400, travel history information associated with a time of acquisition is stored in the storage 230 or 250. Note that, as the travel history information, only a history of current locations within a most recent fixed period of time may be stored.

Then, the calculator 242 calculates an estimated time of delivery to each of the delivery destinations CS, based on the current location of the deliverer terminal 400, the delivery route information 231 as illustrated in FIG. 4, and the travel history information stored in the storage 230 or 250.

At that time, the calculator 242 may calculate an estimated time of delivery to each of the delivery destinations CS by considering a decaying average (an average with less weight given to a more previously acquired value) of current locations in the travel history information.

Besides the above, the calculator 242 may calculate an estimated time of delivery to each of the delivery destinations CS by also considering externally acquired traffic jam information.

As described above, the present disclosure can provide a server device, a delivery status display system, a delivery status response method, and a recording medium that can present a delivery status to a user intelligibly while protecting privacy.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A server device comprising:
an acquirer acquiring a current location from a deliverer terminal being used by a deliverer who delivers an item to a user;
a calculator calculating, based on the current location acquired by the acquirer and delivery route information including a delivery destination where the deliverer stops for a delivery, an estimated time of delivery at which the deliverer is expected to be able to make a delivery to the user;
a receiver receiving inquiry information transmitted from a user terminal being used by the user;
a generator generating, in response to the inquiry information received by the receiver, response information including the estimated time of delivery calculated by the calculator; and
a transmitter transmitting the response information generated by the generator to the user terminal,
wherein the generator generates, based on the delivery route information, the response information further including the current location only when there is no other delivery destination between the current location and a delivery to the user.

2. The server device according to claim 1,
wherein the generator generates the response information including a map image on which a mark indicating the current location is superimposed and a message indicating the estimated time of delivery or time remaining until the estimated time of delivery only when there is no other delivery destination between the current location and a delivery to the user.

3. The server device according to claim 1, further comprising:
an updater controlling the acquirer and the calculator to update the current location and the estimated time of delivery at each predetermined time interval; and
a notifier notifying the user terminal of advance notice information that a delivery is about to be made soon when time remaining until the estimated time of delivery goes below a predetermined threshold value.

4. A delivery status display system in which a deliverer terminal being used by a deliverer who delivers an item to a user, a user terminal being used by a user, and a server device are communicably connected, wherein
the user terminal includes:
a terminal transmitter transmitting inquiry information to the server device;
a terminal receiver receiving response information rent from the server device; and
a display displaying the response information received by the terminal receiver,
the server device includes:
an acquirer acquiring a current location from the deliverer terminal;
a calculator calculating, based on the current location acquired by the acquirer and delivery route information including a delivery destination where the deliverer stops for a delivery, an estimated time of delivery at which the deliverer is expected to be able to make a delivery to the user;
a receiver receiving the inquiry information transmitted from the user terminal;
a generator generating, in response to the inquiry information received by the receiver, the response information including the estimated time of delivery calculated by the calculator; and
a transmitter transmitting the response information generated by the generator to the user terminal, and
the generator generates, based on the delivery route information, the response information further including the current location only when there is no other delivery destination between the current location and a delivery to the user.

5. A delivery status response method executed by a server device, comprising:
acquiring a current location from a deliverer terminal being used by a deliverer who delivers an item to a user;
calculating, based on the acquired current location and delivery route information including a delivery destination where the deliverer stops for a delivery, an estimated time of delivery at which the deliverer is expected to be able to make a delivery to the user;
receiving inquiry information transmitted from a user terminal being used by the user;
generating, in response to the received inquiry information, response information including the calculated estimated time of delivery; and
transmitting the generated response information to the user terminal,
wherein the generating includes generating, based on the delivery route information, the response information further including the current location only when there is no other delivery destination between the current location and a delivery to the user.

6. A non-transitory computer-readable recording medium recording a program, the program causing a computer to execute processing comprising:
acquiring a current location from a deliverer terminal being used by a deliverer who delivers an item to a user;
calculating, based on the acquired current location and delivery route information including a delivery destination where the deliverer stops for a delivery, an estimated time of delivery at which the deliverer is expected to be able to make a delivery to the user;
receiving inquiry information transmitted from a user terminal being used by the user;
generating, in response to the received inquiry information, response information including the calculated estimated time of delivery; and
transmitting the generated response information to the user terminal,
wherein the generating includes generating, based on the delivery route information, the response information further including the current location only when there is no other delivery destination between the current location and a delivery to the user.
